(19) United States
(12) Patent Application Publication
(10) Pub. No.: US 2006/0192968 A1
(43) Pub. Date: Aug. 31, 2006

(54) Optical assembly

(76) Inventors: David Ian Farrant, New South Wales (AU); Alistair Scott Martin, New South Wales (AU); Christopher Hayes Freund, New South Wales (AU); Roger Pryce Netterfield, New South Wales (AU); Jan Herrmann, New South Wales (AU); Denis Leslie Redfern, New South Wales (AU)

Correspondence Address: LADAS & PARRY LLP, 224 SOUTH MICHIGAN AVENUE, SUITE 1600, CHICAGO, IL, 60604, US

(21) Appl. No.: 10/543,984

(22) PCT Filed: Jan. 30, 2004
(86) PCT No.: PCT/AU04/00110

§ 371 Date: Oct. 19, 2005

(30) Foreign Application Priority Data
Jan. 30, 2003 (AU) 2003900377

(51) Int. Cl. G01N 21/55

(52) U.S. Cl. 356/445; 356/239.2

(57) ABSTRACT

An optical assembly comprises an optical device (103); an enclosure (101) for containing the optical device (103), the enclosure (101) including a transparent section (107) to allow passage of a light beam (104) to or from the optical device (103); and means for measuring the attenuation of a test light beam (212) through the transparent section(107). Preferably, the optical assembly also comprises means for compensating for the measured amount of attenuation by adjusting a measurement or a characteristic of the optical device (103) or a related optical device to compensate for the measured amount of attenuation.

### FIELD OF THE INVENTION

The present invention relates to an optical assembly, particularly for use in an industrial environment. The optical assembly preferably includes an enclosure for containing an optical device, the optical device typically being either a light source or a detector, and the enclosure includes a transparent window to allow light to enter or leave the enclosure to or from the optical device.

Industrial environments are often characterised by noise, vibration, temperature, and humidity, and devices used in industrial environments are exposed to fluids, solvents, airborne dust and vapour. It is sometimes desirable to install sensitive equipment in such environments, for example, for the purposes of process monitoring. Depending on the mode of measurement, some or all of the industrial environmental factors may easily be screened or eliminated from interfering with the sensitive equipment.

In particular, optical sensors are commonly used for process monitoring. For instance, in one application disclosed in WO 01/66352 a light source is used to illuminate a test surface, and characteristics of the behaviour of the light resulting from interaction with the surface are measured and quantified by means of optical detectors.

In this situation of optical sensing, elimination of interference from the industrial environment presents some particular challenges. Location of an optical device within an enclosure will prevent ingress of contaminants into the device, but the optical signal or beam must pass through some part of the enclosure in order to interact with the device. A transparent section must therefore be included in the enclosure. However, contamination still builds up on the outside of the transparent section, and may impede the passage of light into or out of the enclosure and adversely effect the measurement. Particularly in unattended operation, there will always be uncertainty regarding the presence and/or the extent of contamination present and this may completely negate any benefit of using the instrument.

### SUMMARY OF THE INVENTION

According to the present invention, an optical assembly comprises:

an optical device;

an enclosure for containing the optical device, the enclosure including a transparent section to allow passage of a light beam to or from the optical device; and

means for measuring the attenuation of a test light beam through the transparent section.

The optical assembly of the present invention has the capacity to measure and thereby monitor the attenuation caused by any contamination that has built up on the transparent section of the enclosure.

The measurement may be used to merely alert an operator when the attenuation reaches a threshold value, indicating that the contamination build up has reached a level where it may be adversely effecting the operation of the optical device. However, preferably the optical assembly includes means for compensating for the measured amount of attenuation. Preferably, a measurement or a characteristic of the optical device or a related optical device is adjusted to compensate for the measured amount of attenuation. If the optical device is a detector, the sensitivity of the detector may be adjusted or the signal from the detector may be adjusted by an appropriate factor. If the optical device is a light source, the brightness of the light source may be adjusted. Rather than adjusting a characteristic of the optical device itself, a characteristic or measurement of an associated device may be adjusted. If the device is part of a source-detector pair, it may be that the other device is adjusted. For example, if the optical device is a source, the signal from the associated detector may be adjusted to compensate for the attenuation of the light beam from the source.

Preferably, the light path to or from the optical device and the test light path intersect substantially at the transparent section. This ensures that the contamination of the transparent section is measured at the same position as the position where the beam from or to the optical device passes through the transparent section.

Preferably, the optical assembly includes a light source and a detector for generating and detecting the test light beam respectively, the light source and the detector being located on opposite sides of the transparent section. Preferably, the light source is located externally to the enclosure and the detector is located inside the enclosure.

Preferably, the transparent section is recessed into the enclosure. This helps to prevent airborne dust and other contaminants from reaching and building up on the transparent section. Preferably, the transparent section is located in an enclosed passage, and the light path through the transparent section passes along the length of the passage.

Preferably, when the test light beam is generated by a test source and detected by a test detector, the component which is located outside the enclosure is recessed. This prevents contamination from building up and affecting the performance of the external component. Preferably, the external component is located in a passage through which the test beam passes.

In a preferred aspect of the present invention, the optical assembly includes means for directing a flow of gas onto an external surface of the transparent section, to reduce build up of contaminants on the surface. Cleaning fluid may be introduced in the flow of gas.

In this preferred aspect of the present invention, the flow of gas directed at the external surface of the transparent section serves to substantially reduce build up of contaminants on the surface which would otherwise attenuate the emitted or received beam, and adding cleaning fluid to the flow cleans away any residue which has built up.

Preferably, the flow of gas is compressed gas, and more preferably compressed air.

Preferably, the flow of gas is directed along the passage in which the external component of the test source-detector pair is located, and the flow is directed away from the external component and is incident on the transparent section. Furthermore, the flow of gas along the passage away from the test light source or detector also prevents build up of contaminants on the test source or detector.

In one embodiment, wherein the optical device is a light source, the optical assembly preferably includes a beam splitter located inside the enclosure and arranged to direct a portion of the beam into a test detector which is also arranged to detect the test beam. This enables the test detector to also be used to measure the output of the light source, to enable a final measurement result to be adjusted for variations in the light output of the source, as well as being adjusted to allow for attenuation of the beam by contamination of the transparent situation.

In another embodiment, wherein the optical device is a detector, the detector can be arranged to detect both the test beam and a primary beam. When the light source for the primary beam is deactivated, and the light source for the test beam is activated, the detector receives light intensity from the primary beam, and vice versa. The advantage of this configuration is that it is simpler and requires fewer components.

### BRIEF DESCRIPTION OF THE DRAWINGS

Preferred embodiments of the present invention will now be described with reference to the accompanying drawings, in which;

FIG. 1 is a schematic drawing of a first embodiment of the present invention;

FIG. 2 is a schematic drawing of a second embodiment of the present invention in which the optical device is a light source;

FIG. 3 is a schematic drawing of a third embodiment of the present invention;

FIG. 4 is a schematic drawing of a fourth embodiment in which the optical device is a detector; and

FIG. 5 is an elevated view of an embodiment of the invention.

### DETAILED DESCRIPTION

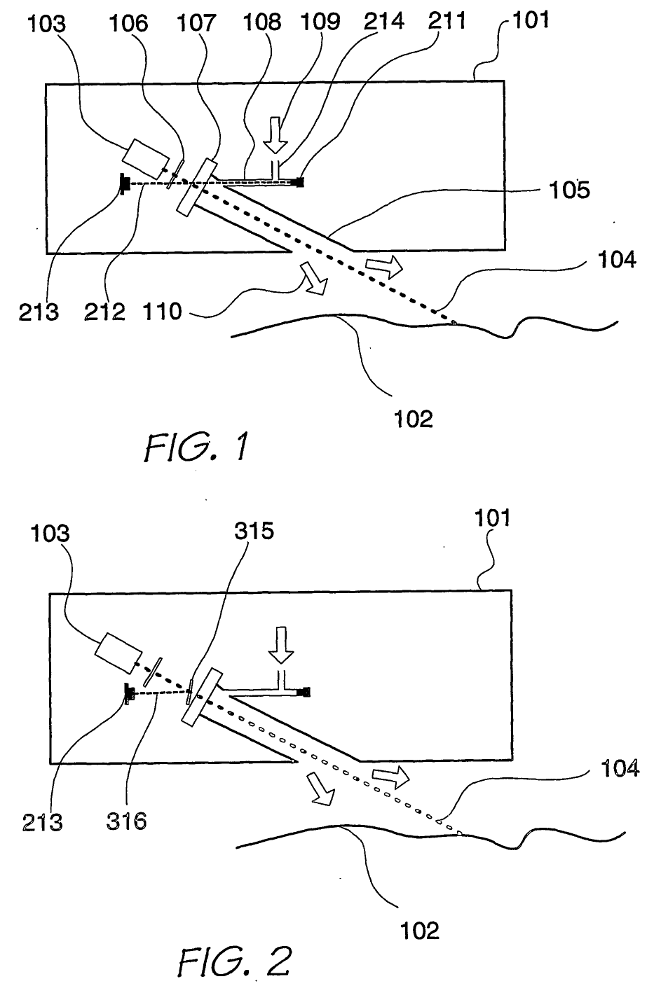

FIG. 1 illustrates a sealed enclosure 101 containing an optical device 103. The enclosure 101 is constructed to meet one of the most stringent requirements for electrical enclosures (e.g. IP67) including the requirement of being able to be totally immersed in water without leakage.

The enclosure 101 is positioned relative to a surface 102 to be measured. Optical device 103 represents, in one embodiment, an optical source e.g. LED or laser etc, or in another embodiment an optical detector. A light pathway 104 is shown to describe the motion of light either (a) from the source 103 to the surface 102 or vice versa in the case of the device 103 being a detector. The light beam travels along a passage 105 that recesses the window 107 into the enclosure 101. Other optical elements such as filters, polarisers, lenses etc may be located between the optical device 103 and the enclosure window 107. Sealing of the enclosure 101 is accomplished using a window 107 that is attached into the enclosure 101 in such a manner as to exclude contamination e.g. by means of an O-ring seal. Compressed gas is directed onto the external surface of the window 107 through passage 108. The compressed gas is supplied from an external supply at a controlled pressure 109. The compressed gas, having flowed across the window surface, travels along the passage 105 and is exhausted to ambient 110. Bursts of cleaning fluid may be introduced upstream in the compressed gas stream so that it travels down passage 108 and is applied to window 107 and cleans away any residue on the window 107.

FIG. 1 illustrates an arrangement for the diagnosis of window contamination. Gas tube 108 accommodates a test light source 211 that projects a test beam along gas tube 108 onto and through window 107. The transmitted light continues to follow path 212 and finally falls onto test detector 213 where it is converted into an electrical signal. Light path 212 is configured to intersect light path 104 substantially at the window 107.

The method of contamination diagnosis involves initial calibration of the signal from test detector 213 when test light source 211 is activated and when window 107 is in a contamination-free state. This is preferably conducted at or shortly after manufacture, but before installation in the contaminating environment. The signal from test detector 213 in the contamination-free state is measured and recorded by electronic systems associated with the optical device 103—this value is called ID₀. Following the installation of the optical device 103 in the potentially contaminating environment, a similar operation of measuring the signal from test detector 213 is conducted to give a value called IDₜ. Test light source 211 is only activated when test detector 213 is being measured; for the rest of the time it is off. If contamination has been able to attach to the external surface of window 107, such that it impedes primary light path 104, then it will also impede test light path 212 which will result in less light intensity falling on test detector 213 and give rise to less electrical signal IDₜ. A comparison of IDₜ with the stored value ID₀ will determine whether IDₜ has decreased as a result of contamination on window 107.

In order to accommodate test light source 214, the gas flow is introduced into tube 108 via a T-junction 214. The advantage of this configuration is that test light source 211 is located at a position separated from the contaminating environment by a tortuous path as well as being protected by a gas flow opposing the ingress of contamination. Positioning light source 211 at this position significantly reduces the probability of contamination.

In a further refinement of the invention, the sensor system may be made to be substantially tolerant to moderate levels of contamination on window 107. Assuming the properties of light paths 212 and 104 are attenuated by contamination in substantially similar extents, then the contamination induced attenuation in test light path 212 may be used as an estimate for the attenuation in primary light path 104 caused by contamination on window 107. Attenuation in test light path 212 can be enumerated as:

$$Attenuation = \frac{{ID}_{t}}{{ID}_{0}} .$$

Using this value as an estimate for the attenuation in primary light path 104, a correction can be applied to the measured signal from detector 103. Thus:

$${IS}_{Ct} = \frac{{IS}_{t} \times {ID}_{0}}{{ID}_{t}}$$

Where ISₜ is the measured signal from detector 103 at or after measurement IDₜ, and IS_{Ct} is a corrected value for detector 103, based on the estimated effect of contamination.

If optical device 103 is a source, the measured signal from an associated detector may be adjusted, or the brightness of the source may be adjusted.

In a preferred method, IDₜ will be measured frequently perhaps daily, hourly or even more frequently depending on the probability of contamination and its impact on the measurement efficacy or downstream use.

The embodiment shown in FIG. 1 depicts a configuration in which the measurement light path 104 makes an angle of approximately 60 degrees with the normal of the measurement surface 102. It will be recognised by a person skilled in the art that the principles described are not limited to this configuration and that any angle can be accommodated. It will also be recognised that a multiplicity of angles and configurations may be combined in a single instrument or enclosure.

As illustrated in FIG. 2, the addition of a beam splitter 315 into the configuration already shown in FIG. 1 enables the output of a primary light source 103 to be measured. This maybe important in applications where measurement accuracy requirements are beyond the stability specifications of the light source output. FIG. 2 shows a beam splitter 315 inserted into the same configuration as FIG. 1. Much of the common labelling has been omitted for clarity. In the instance in which 103 is a light source, the output light path 104 travels from the source 103 towards the measurement surface 102. When it passes the beam splitter 315 a small proportion of the light intensity is reflected along path 316 and impinges on test detector 213 where it is converted into an electrical signal. The electrical signal may be used as a diagnostic measure by comparing periodic measurements with a stored initial value such that gradual or sudden changes in light output may be identified and an error signal or alarm triggered. Alternatively (or additionally) the electrical signal may be used to normalise the results of any subsequent optical measurement for which the light source 103 supplies light intensity e.g. the measurement of an associated detector. Small variations in light output of source 103 may, in this way, be corrected and their effects substantially eliminated from a final measurement result.

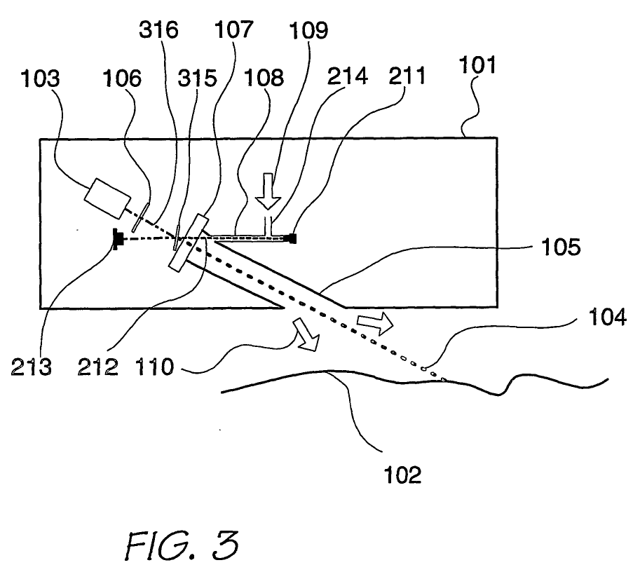

FIG. 3 shows an embodiment of a single optics tube in which all of the previously described features have been combined. In order to operate the full range of features possible, the light sources 103 and 211 must be individually controlled. In order to measure window contamination test light source 211 must be activated and 103 deactivated. In order to measure the light output of primary light source 103, primary light source 103 must be activated and test light source 211 deactivated.

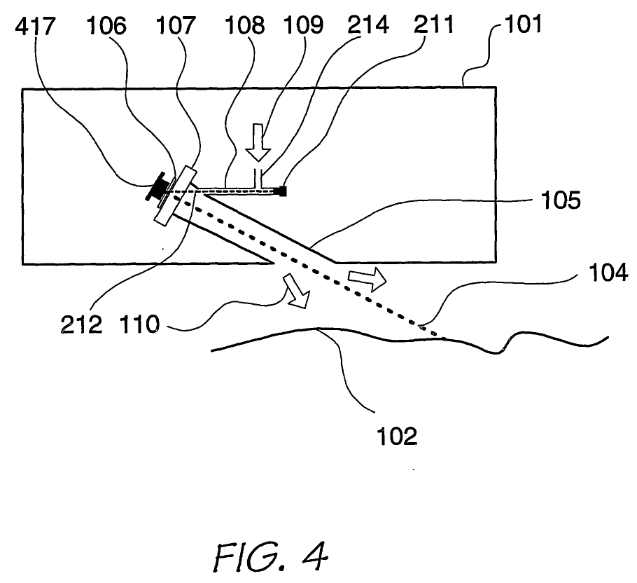

If the physical configuration permits, a simplified embodiment of the contamination diagnostic device may be employed as depicted in FIG. 4. The sensor detector 417 is used to receive the measurement signal along light path 104, but when the light source for light path 104 is deactivated and test light source 211 is activated the detector 417 receives light intensity from the direction of test light path 212. Both light paths travel through the optical element 107 that seals the instrument's enclosure 101. Therefore, the use of test light path 212 can be used in order to measure the presence and degree of contamination on optical element 107. The same method of correcting for contamination on optical element 107 can be used as previously described. Test light source 211 and test light path 212 travel along tube 108 (as described previously) and are protected from the possible ingress of contamination coming up tube 105.

The advantage of this configuration is that it is significantly simpler than the embodiments that have preceded. However, it can only be used in situations in which detector 417 is capable of measuring light intensity and also where the geometric configuration permits both light paths 212 and 104 to be incident on a single detector 417. It will be recognised by one skilled in the art that FIG. 4 represents only one of many geometric configurations that satisfy these criteria.

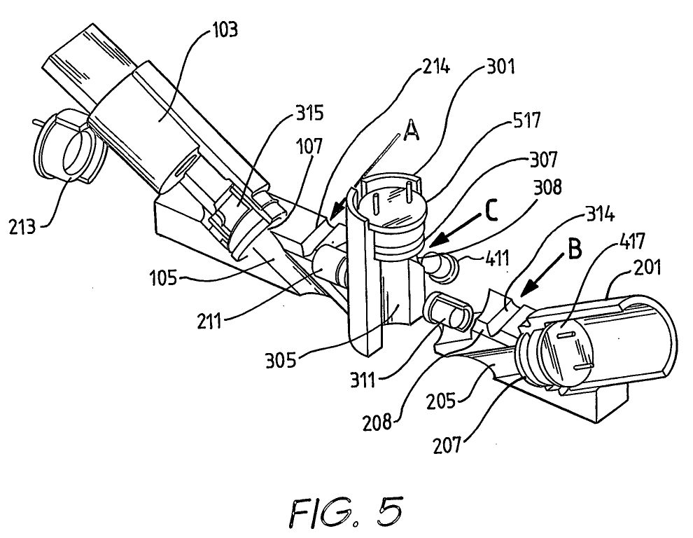

FIG. 5 shows an actual embodiment, having a source assembly for directing a beam of light at a surface, and two detector assemblies arranged at different orientations to detect light scattered and reflected from the surface, respectively.

The source assembly has the arrangement shown in schematic FIG. 2, and includes a source 103 located in an enclosure (not shown) having a transparent window 107 for allowing passage of the beam emitted by the source 103. The beam emitted from the source 103 passes along passage 105 to be incident on a surface. Inside the enclosure (not shown), between the window 107 and the source 103 is a beam splitter 315 which directs a portion of the emitted beam on to a detector 213. A test source 211 is located at the end of a recessed passage (not shown) to direct a test beam through the window 107 to be incident onto detector 213. When the source 103 is switched on, detector 213 receives a portion of the emitted beam from the beam splitter 315, and when the source 103 is switched off, the test source 211 is switched on, and the detector 213 detects the test beam. A flow of air A passes along passage 214 to join the passage in which the test source 211 is located at a T-junction. A flow of air thus is directed away from test source 211 and is incident on window 107.

Both detector assemblies have the arrangement shown in schematic FIG. 4, wherein the same detector 417, 517 is used to detect incident radiation from the surface, and the test beam is generated by a test source 311, 411. Each detector 417, 517 is located in an enclosed chamber 201, 301 such that a detecting surface of the detector 417, 517 is adjacent a window 207, 307. The window 207, 307 is recessed such that incoming light passes along a passage 205, 305 to be incident on the window 207, 307. A test source 311, 411 directs a test beam at the window 207, 307 along a passageway 208, 308. The test beam passes through the window 207, 307 and is detected by the detector 417, 517. A flow of air B, C is directed into the passage 208, 308 from a side passage 314 such that the air flow is directed along passage 208, 308 away from the test source 311, 411 and is incident on the window 207, 307.

For the purposes of this specification it is to be clearly understood that the word “comprising” means “including but not limited to”, and that the word “comprises” has a corresponding meaning.

Modifications and variations as would be apparent to a skilled addressee are deemed to be within the scope of the present invention.

1. An optical assembly comprising:
an optical device;
an enclosure for containing the optical device, the enclosure including a transparent section to allow passage of a light beam to or from the optical device;
means for measuring the attenuation of a test light beam through the transparent section; and
means for compensating for the measured amount of attenuation.

2. An optical assembly according to claim 1, wherein the means for compensating for the measured amount of attenuation comprises means to adjust a measurement or a characteristic of the optical device or a related optical device to compensate for the measured amount of attenuation.

3. An optical assembly according to claim 1, arranged such that the light path to or from the optical device and the test light path intersect substantially at the transparent section.

4. An optical assembly according to claim 1, wherein the transparent section is recessed into the enclosure.

5. An optical assembly according to claim 4, wherein the transparent section is located in an enclosed passage, and the light path through the transparent section passes along the length of the passage.

6. An optical assembly according to claim 1, including a light source and a detector for generating and detecting the test light beam respectively, the light source and the detector being located on opposite sides of the transparent section.

7. An optical assembly according to claim 6, wherein the source or detector which is located outside the enclosure, is recessed.

8. An optical assembly according to claim 7, wherein the external component is located in a passage through which the test beam passes.

9. An optical assembly according to claim 8, and further comprising means for applying a flow of gas directed along the passage away from the external component, and is incident on the transparent section.

10. An optical assembly according to claim 1 and including means for directing a flow of gas to be incident on an external surface of the transparent section to reduce build up of contaminants on the external surface.

11. An optical assembly according to claim 10, wherein the flow of gas is compressed gas.

12. An optical assembly according to claim 1, wherein the optical device is a light source, and the optical assembly includes a beam splitter located inside the enclosure and arranged to direct a portion of the beam from the light source into a test detector which is also arranged to detect the test beam.

13. An optical assembly according to claim 1, wherein the optical device is a detector, and the detector is arranged to detect both the test beam and a primary beam.

14. An optical assembly according to claim 8 and further comprising (a) means for directing a flow of gas to be incident on an external surface of the transparent section to reduce build up of contaminants on the external surface, (b) the mans for directing a flow of gas including a compressed gas source, (c) the optical device is a light source, and the optical assembly includes a beam splitter located inside the enclosure and arranged to direct a portion of the beam from the light source into a test detector which is also arranged to detect the test beam.

15. An optical assembly according to claim 14, and wherein the optical device is a detector, and the detector is arranged to detect both the test beam and a primary beam.
